(19) United States
(12) Patent Application Publication
(10) Pub. No.: US 2025/0055397 A1
(43) Pub. Date: Feb. 13, 2025

(54) BRUSHLESS WOUND FIELD SYNCHRONOUS MACHINES

(71) Applicant: Tula eTechnology, Inc., San Jose, CA (US)

(72) Inventors: Zhiqian CHEN, Palo Alto, CA (US); Philippe FARAH, Mamer (LU); John W. PARSELS, San Jose, CA (US)

(21) Appl. No.: 18/756,619

(22) Filed: Jun. 27, 2024

Related U.S. Application Data
(60) Provisional application No. 63/518,403, filed on Aug. 9, 2023.
(60) Provisional application No. 63/597,449, filed on Nov. 9, 2023.

(51) Int. Cl. H02P 25/022; H02K 11/04; H02K 11/33

(52) U.S. Cl. CPC H02P 25/022; H02K 11/04; H02K 11/33

(57) ABSTRACT

An electric machine is provided. A transformer comprises a magnetic coupling. A wound field synchronous machine comprises a rotor winding, a secondary circuit of the transformer electrically connected to the rotor winding, and a stator winding. The secondary circuit comprises a secondary winding, a rectifier electrically, a switch for switching voltage between the rotor winding and the rectifier in a first direction, and an energy storage arranged to store energy provided by the rectifier and the rotor winding and provide a voltage to the rotor winding in a second direction. A power converter is coupled between the power supply and the wound field synchronous machine. The power converter comprises a stator winding power supply arranged to provide multiple phase AC excitation to the stator winding and a primary circuit of the transformer comprising a primary winding arranged to provide AC power to the primary winding.

### CROSS-REFERENCE TO RELATED APPLICATIONS

This application claims the benefit of priority of U.S. Application Nos. 63/518,403, filed Aug. 9, 2023 and 63/597,449, filed Nov. 9, 2023, both of which are incorporated herein by reference for all purposes.

### BACKGROUND

The present application relates generally to wound field synchronous machines to selectively deliver a desired output in a more energy efficient manner. Wound field machines are sometimes alternatively described as externally excited synchronous machines, but this alternative name refers to the same device design.

The term “machine” as used herein is intended to be broadly construed to mean both electric motors and generators. Electric motors and generators both include a stator having a number of poles and a rotor. Some machines operate as both electric motors and generators. When a machine is operating as a motor, it converts electrical energy into mechanical energy. When operating as a generator, the machine converts mechanical energy into electrical energy.

### SUMMARY

A variety of methods, controllers, and electric machine systems are described that facilitate pulsed control of multiple electric machines (e.g., electric motors and generators) drive systems to improve the energy conversion efficiency of the electric machines when operating conditions warrant. More specifically, an electric machine is provided with a power supply. A transformer comprises at least one magnetic coupling. A wound field synchronous machine comprises a rotor winding, a secondary circuit of the transformer electrically connected to the rotor winding, and a stator winding. The secondary circuit, comprises a secondary winding, a rectifier electrically connected across the secondary winding, at least one switch for switching voltage between the rotor winding and the rectifier in a first direction, and an energy storage arranged to store energy provided by the rectifier and the rotor winding and provide a voltage to the rotor winding in a second direction opposite the first direction when the switch switches off voltage between the rotor winding and the rectifier. A power converter is coupled between the power supply and the wound field synchronous machine. The power converter comprises a stator winding power supply arranged to provide multiple phase AC excitation to the stator winding and a primary circuit of the transformer comprising a primary winding arranged to provide AC power to the primary winding.

In another embodiment, a method for providing excitation for rotor winding in an externally excited synchronous machine is provided. An AC excitation of a primary winding is provided. The AC excitation is received on a secondary winding from the primary winding, generating an AC voltage. The AC voltage is rectified to provide a DC voltage. The DC voltage is applied to a rotor winding. The DC voltage is switched between on and off to provide a pulsed DC voltage, wherein when the pulsed DC voltage is on, the pulsed DC voltage is applied in a first direction to the rotor winding and an energy storage and wherein when the pulsed DC voltage is off the energy storage applies a voltage in a second direction opposite the first direction to the rotor winding.

These and other features of the present disclosure will be described in more detail below in the detailed description of the disclosure and in conjunction with the following figures.

### BRIEF DESCRIPTION OF THE DRAWINGS

The invention and the advantages thereof may best be understood by reference to the following description taken in conjunction with the accompanying drawings in which:

FIG. 1 is a schematic illustration of a wound field synchronous machine system, that may be used in an embodiment.

FIG. 2 is a schematic cross-section of a part of a wound field synchronous machine.

FIGS. 3A-B are schematic views of brushless rotor excitation circuits and control circuits that are used in some embodiments.

FIGS. 4A-B are logic charts used in some embodiments.

FIG. 5 is a schematic view of brushless rotor excitation circuits that are used in some embodiments using half-wave rectification.

FIG. 6 is a schematic view of brushless rotor excitations that are used in some embodiments with a three-phase AC system.

FIGS. 7A-C are schematic views of a secondary circuit illustrating current flow in some embodiments.

FIG. 8 is a schematic view of a secondary circuit that allows for a reduced capacitor.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

Modern electric machines have relatively high energy conversion efficiencies. The energy conversion efficiency of most electric machines, however, can vary considerably based on their operational load. With many applications, a machine is required to operate under a wide variety of different operating load conditions. As a result, machines typically operate at or near the highest levels of efficiency at certain times, while at other times, they operate at lower efficiency levels.

Wound Field Synchronous Machines (WFSM), also known as Externally Excited Synchronous Machines or Electrically Excited Synchronous Machines (EESM) are a type of machine that excites the flux field on the rotor with an independent circuit rather than using stator windings or permanent magnets. This type of machine has proved to be more efficient at high-speed operations because the magnetic field can be optimally controlled. Conventionally, WFSMs use brushes to provide current to the rotor winding. However, brushes wear over extended usage. The brushes are pressed by springs to guarantee contact with the slip rings which increases mechanical friction; the brushes and slip rings need to be separated and sealed from the other parts of the rotor to prevent a short circuit to the power supply in case oil cooling is used.

In most wound field synchronous machines, the armature windings are powered by an AC power source. In most wound field synchronous machines, the field coil is on the rotor and the armature windings are on the stator. In such wound field synchronous machines, slip rings or brushes may be used to provide electrical contacts between the DC power source and the field coils on the rotor.

### Three-Phase Wound Field Synchronous Machine

In a three-phase wound field synchronous machine, the stator may include a three-coil winding that is excited by a three-phase AC input, providing AC excitation, and the field windings are on the rotor that are powered by a DC input. When the three-phase AC input is passed through the three-phase armature (stator) windings, a rotating magnetic field (RMF) is generated. The rotational rate of the RMF is known as the synchronous speed (Ns) of the electric machine. The interaction of the field (rotor) winding fields and armature winding fields generates an electromagnetic force (EMF) causing the rotor rotation.

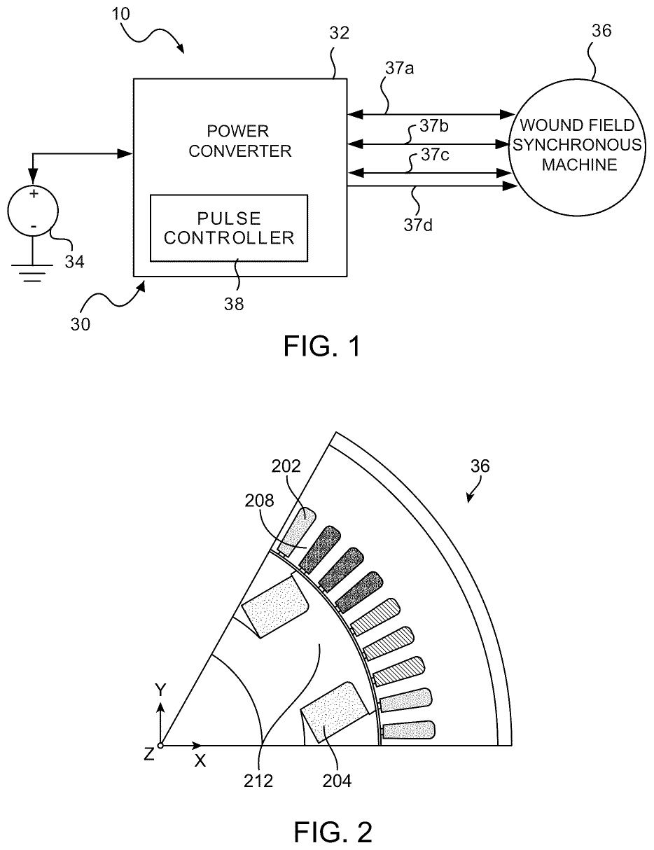

FIG. 1 is a schematic illustration of a wound field synchronous machine system 10, that may be used in an embodiment. The wound field synchronous machine system 10 comprises a DC power supply 34, a power controller 30, and a wound field synchronous machine 36. In some embodiments, the power controller 30 comprises a power converter 32 and a pulse controller 38. In some embodiments, the power converter 32 does not have a pulse controller 38. The power converter 32 may be operated as a power inverter or power rectifier depending on the direction of energy flow through the system. When the electric machine is operated as a motor, the power converter 32 is responsible for generating three-phased AC power from the DC power supply 34 to drive the wound field synchronous machine 36. The three-phased input power, denoted as phase A 37a, phase B 37b, and phase C 37c, is applied to the windings of the stator of the wound field synchronous machine 36 for generating the RMF as described above. The power converter 32 is a stator winding power supply. The lines depicting the various phases, 37a, 37b, and 37c are depicted with arrows on both ends indicating that current can flow both from the power converter 32 to the wound field synchronous machine 36 when the machine is used as a motor and that current can flow from the wound field synchronous machine 36 to the power converter 32 when the machine is used as a generator. When the electric machine is operating as a generator, the power converter 32 operates as a power rectifier, and the AC power coming from the wound field synchronous machine 36 is converted to DC power, which is stored in the DC power supply 34. The line depicting the field current, 37d carries a DC field current for the rotor that typically is unidirectional for both the motor and generator operating modes.

The pulse controller 38 is, in some embodiments, responsible for selectively pulsing the three-phased input power and the DC power to the field coil to provide a pulsed DC voltage. During conventional (i.e., continuous) operation, the three-phased field coil input power is controlled to generate the optimal magnetic field for a given operating condition. In other embodiments, a pulsed operation is provided, where the three-phased and field coil input power is pulsed. In all embodiments, fast control of the magnetic field is valuable to operate safely and generate or absorb the appropriate amount of torque at optimal efficiency.

FIG. 2 is a schematic cross-section of a part of a wound field synchronous machine 36. The wound field synchronous machine 36 has a stator winding 202 powered by a multi-phase AC and rotor winding 204 powered by DC. The stator winding 202 is wound around parts of the stator 208. The rotor winding 204 is wound around parts of the rotor 212.

### Rotor Excitation Circuit

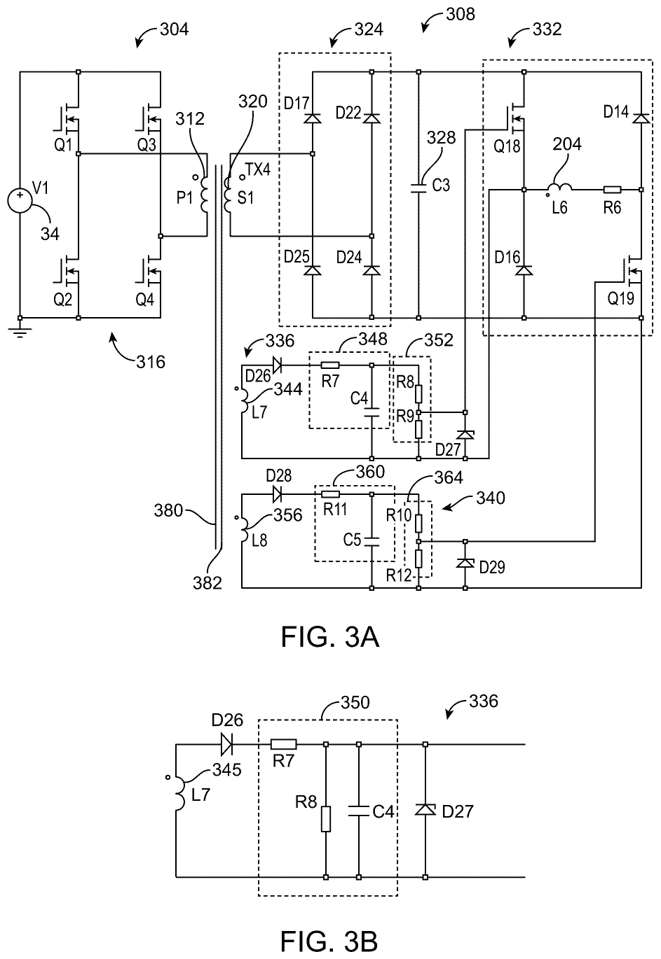

FIG. 3A is a schematic view of brushless rotor excitation circuits that are used in some embodiments. The brushless rotor excitation circuits comprise a primary circuit 304 and a secondary circuit 308. In some embodiments, the primary circuit 304 is part of the power converter 32 connected to the DC power supply 34.

In some embodiments, the primary circuit 304 comprises a primary winding 312 and an H-bridge single-phase DC to AC inverter 316. The H-bridge 316 has a first switch Q1 and a second switch Q2 on a first side of the H-bridge 316 and a third switch Q3 with a fourth switch Q4 on a second side of the H-bridge 316. In some embodiments, the first switch Q1 and the third switch Q3 are at the top-end of the H-bridge 316 and the second diode Q2 and the fourth switch Q4 are at the bottom-end of the H-bridge 316. The primary winding 312 of the transformer is the load of the H-bridge 316. The primary circuit 304 provides AC excitation to the primary winding 312.

In some embodiments, the secondary circuit 308 comprises a secondary winding 320, a full-wave rectifier 324, energy storage 328, and a secondary H-bridge DC to DC converter 332. The full-wave rectifier 324 comprises four diodes arranged to convert AC voltage from the secondary winding 320 to a DC voltage. The secondary H-bridge 332 is electrically connected to the full-wave rectifier 324 so that the DC voltage provides power to the secondary H-bridge 332. In some embodiments, the secondary H-bridge 332 has a first switch Q18 with a second diode D16 on a first side of the secondary H-bridge 332 and a first diode D14 with a second switch Q19 on a second side of the secondary H-bridge 332. In some embodiments, the first switch Q18 and the first diode D14 are at the top-end of the secondary H-bridge 332 and the second diode D16 and the second switch Q19 are at the bottom-end of the secondary H-bridge 332. The rotor winding 204 is the load of the secondary H-bridge 332. In some embodiments, the energy storage 328 is connected in parallel to the full-wave rectifier 324 and the secondary H-bridge 332. In some embodiments, the energy storage 328 is a capacitor C3. In some embodiments, the energy storage 328 is an inductor or a battery.

In some embodiments, a first control circuit 336 is provided to control the first switch Q18 of the secondary circuit 308, and a second control circuit 340 is provided to control the second switch Q19 of the secondary circuit 308. In some embodiments, the first control circuit 336 comprises a first control circuit secondary winding 344, a low pass filter 348, and a voltage divider 352. In some embodiments, the second control circuit 340 comprises a second control circuit secondary winding 356, a low pass filter 360, and a voltage divider 365. In some embodiments, the low pass filters 348, 360 comprise a resistor and a capacitor. In some embodiments, the voltage dividers 352, 364 comprise one or more Zener diodes. The voltage dividers 352, 364 allow and incoming voltage to be reduced to a voltage needed to control the first switch Q18 or second switch Q19, for example, 15 volts.

In some embodiments, the first control circuit 336 and the second control circuit 340 have a full-wave rectifier in place of the half-wave rectifier. In some embodiments, the functions of the low pass filter and voltage divider can be combined in the same circuit. FIG. 3B is a schematic view of another embodiment of a first control circuit 336 that may be used in an embodiment. The first control circuit 336 provided in FIG. 3B comprises a first control circuit secondary winding 345 and a circuit of a combined low pass filter and a voltage divider 350.

A rotary transformer may comprise a stationary magnetic coupling 380 on the primary side and a rotating magnetic coupling 382 on the secondary side. The stationary magnetic coupling 380 provides magnetic coupling for the primary winding 312. The rotating magnetic coupling 382 provides magnetic coupling for the secondary winding 320. In some embodiments, both magnetic couplings may rotate or be stationary. In some embodiments, the magnetic couplings may have other configurations.

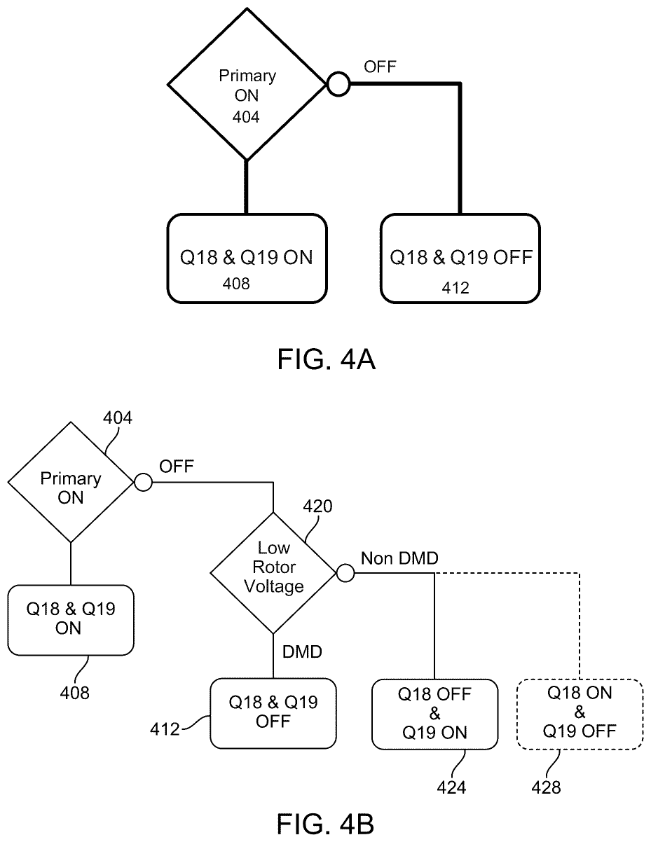

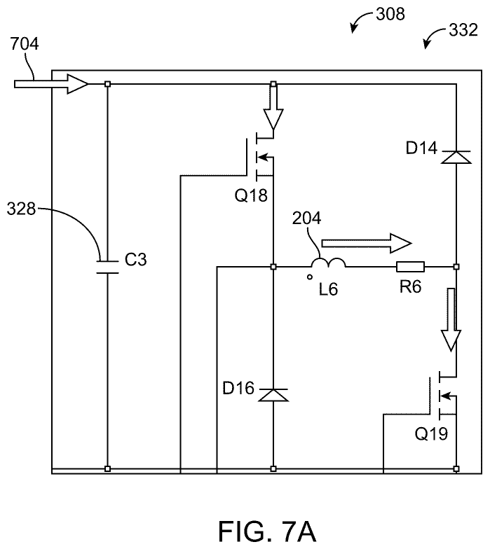

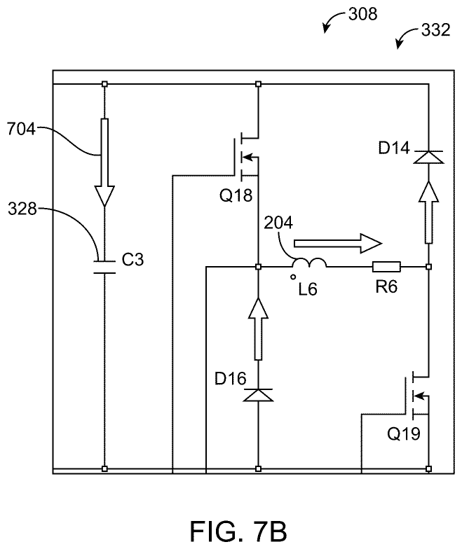

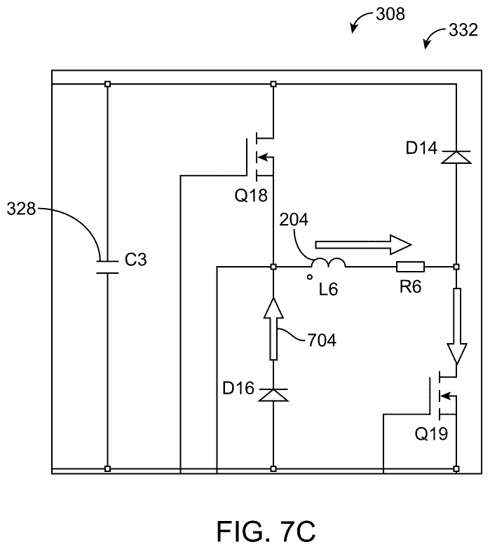

FIG. 4A is a logic chart of an embodiment. In this embodiment, when the primary is on (step 404) an AC voltage is applied on the primary winding 312 so that the first switch Q18 and second switch Q19 are closed (step 408) and a DC voltage from the full-wave rectifier 324 is applied to the energy storage 328 and the rotor winding 204 in a first direction, creating a magnetic field in the rotor winding 204. FIG. 7A is a schematic view of part of the secondary circuit 308 shown in FIG. 3A, showing the energy storage 328 and the secondary H-bridge 332, comprising the rotor winding 204, the first switch Q18, the first diode D14, the second switch Q19, and the second diode D16. FIG. 7A shows the current flow 704 when the primary winding 312 (shown in FIG. 3A) is providing power causing the first switch Q18 and the second switch Q19 to close. Current 704 from the secondary winding 320 (shown in FIG. 3A) generated from the primary winding 312, flows through the first switch Q18, through the rotor winding 204, and then through the second switch Q19, as shown.

When there is no voltage applied on the primary winding 312, so that the primary winding 312 is Off, the first switch Q18 and second switch Q19 are open (step 412), so that the DC voltage on the energy storage 328 applies a reverse voltage to the rotor winding 204 in a second direction opposite the first direction, causing the current and magnetic field to be reduced faster than if zero voltage was applied to the rotor winding 204. As a result, the energy storage 328 stores energy originally stored in the rotor winding 204 and uses the energy to provide a negative voltage on the rotor winding 204, when the first switch Q18 and second switch Q19 are open, instead of allowing the energy to be wasted on the equivalent internal resistance R6 or any external resistor (not shown in the figure). In addition, by providing a reverse voltage, the energy storage 328 causes the current in and magnetic field of the rotor winding 204 to more quickly drop, reducing back EMF in the motor and further increasing efficiency. Back EMF higher than battery voltage generates uncontrolled braking torque which may lead to dangerous situations on electric vehicles. FIG. 7B is a schematic view of part of the secondary circuit 308 shown in FIG. 3A, showing the energy storage 328 and the secondary H-bridge 332, comprising the rotor winding 204, the first switch Q18, the first diode D14, the second switch Q19, and the second diode D16. FIG. 7B shows the current flow 704, when the primary winding 312 (shown in FIG. 3A) is not providing power causing the first switch Q18 and the second switch Q19 to open. Current 704 from the energy storage 328 flows through the second diode D16, through the rotor winding 204, and then through the first diode D14, as shown. The reverse voltage provided by the energy storage in the second direction causes the current flow 704 to be reduced more quickly, although the current through the rotor winding 204 continues to flow in the first direction.

Because the first switch Q18 and the second switch Q19 are on the rotating rotor, some embodiments provide controllers for the first switch Q18 and the second switch Q19 that are on the rotating rotor so that contacts are not needed between the rotating rotor and a stationary controller. The first control circuit 336 and the second control circuit 340 provide controllers for the first switch Q18 and the second switch Q19 that rotate with the rotor. The first control circuit 336 and the second control circuit 340 are powered by the first control circuit secondary winding 344 and the second control circuit secondary winding 356, so that information for controlling the first switch Q18 and the second switch Q19 is provided by the primary winding 312 without contact. In some embodiments, when an AC is applied to the primary winding 312, the first switch Q18 and the second switch Q19 are turned on (closed). When the AC is removed from the primary winding 312, the first switch Q18 and the second switch Q19 are turned off (open). Some embodiments may use other devices to control the first switch Q18 and the second switch Q19. Such devices may be optical or high frequency inductive or capacitive devices or wireless communication.

### Half-Wave Rectifier Rotor Excitation Circuit

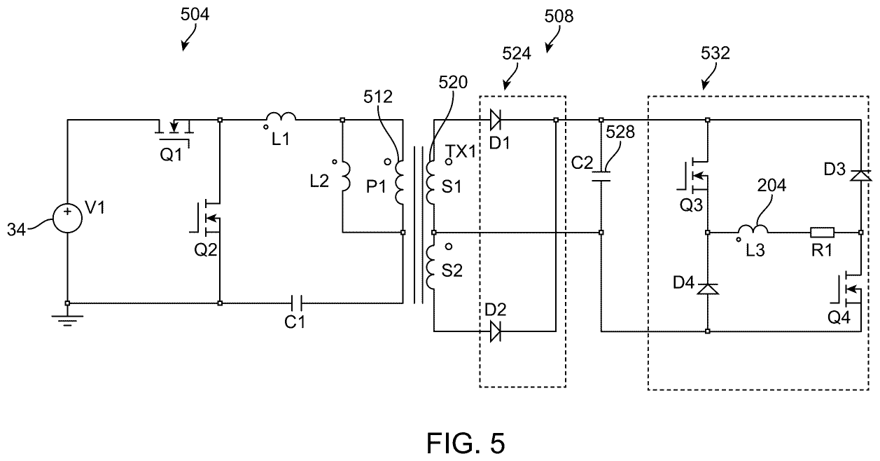

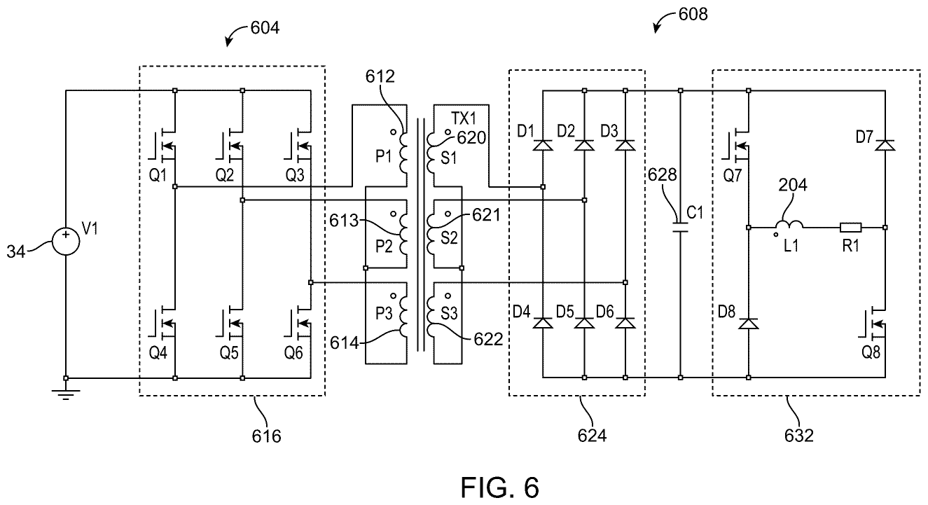

FIG. 5 is a schematic view of brushless rotor excitation circuits that are used in some embodiments using an LLC (inductor-inductor-capacitor) resonant circuit with soft switching control on the primary side and half-wave rectification on the secondary side. The brushless rotor excitation circuits comprise a primary circuit 504 and a secondary circuit 508. In some embodiments, the primary circuit 504 is part of the power converter 32 connected to the DC power supply 34.

In some embodiments, the primary circuit 504 comprises a primary winding 312, a first switch Q1 with a second switch Q2. Part of the primary circuit 504 forms a resonant LLC (inductor-inductor-capacitor) circuit, enabling soft switching to obtain a high frequency AC, allowing for a reduced transformer size.

In some embodiments, the secondary circuit 508 comprises a secondary winding 520, a half-wave rectifier 524, energy storage 528, and a secondary H-bridge converter 532. The half-wave rectifier 524 comprises two diodes arranged to convert AC voltage from the secondary winding 520 to a DC voltage. The secondary H-bridge converter 532 is electrically connected to the half-wave rectifier 524 so that the DC voltage provides power to the secondary H-bridge 532. In some embodiments, the secondary H-bridge 532 has a first switch Q3 with a second diode D4 on a first side of the secondary H-bridge 532 and a first diode D3 with a second switch Q4 on a second side of the secondary H-bridge 532. In some embodiments, the first switch Q3 and the first diode D3 are at the top-end of the secondary H-bridge 532 and the second diode D4 and the second switch Q4 are at the bottom-end of the secondary H-bridge 532. The rotor winding 204 is the load of the secondary H-bridge 532. In some embodiments, the energy storage 528 is connected in parallel to the half-wave rectifier 524 and the secondary H-bridge 532. In some embodiments, the energy storage 528 is a capacitor C2. In some embodiments, the half-wave rectifier 524 is replaced with a full-wave rectifier if the power is relatively high.

The primary circuit 504 and secondary circuit 508 allow for the use of high frequency AC in a range from 10 kilohertz (kHz) to 1,000 kHz. The high frequency AC allows for a small transformer size using soft switching, which turns transistors on and off at zero current (Zero-Current-Switching ZCS) or zero voltage (Zero-Voltage-Switching ZVS), greatly reducing the loss during switching.

### Three-Phase System

FIG. 6 is a schematic view of parts of brushless rotor excitation circuits that are used in some embodiments with a three-phase AC system. The brushless rotor excitation circuits comprise a primary circuit 604 and a secondary circuit 608. In some embodiments, the primary circuit 304 is part of the power converter 32 connected to the DC power supply 34.

In some embodiments, the primary circuit 604 comprises a first phase primary winding 612, a second phase primary winding 613, a third phase primary winding 614, and a switch system 616 between the DC power supply 34 and the first phase primary winding 612, the second phase primary winding 613, and the third phase primary winding 614. The primary circuit 304 provides three phase AC excitation to the primary winding 312.

In some embodiments, the secondary circuit 608 comprises a first phase secondary winding 620, a second phase secondary winding 621, a third phase secondary winding 622, a rectifier 624, an energy storage 628, and a secondary H-bridge DC to DC converter 632. The rotor winding 204 is the load of the secondary H-bridge 632. In some embodiments, the energy storage 628 is connected in parallel to the secondary H-bridge 632. In some embodiments, the energy storage 628 is a capacitor C1. In some embodiments, the energy storage 628 is an inductor or a battery.

### Pulsed Torque Control

Some embodiments may be used in pulsed engine control. Pulsed control is described in U.S. patent application Ser. No. 16/353,159 filed on Mar. 14, 2019, and U.S. Provisional Patent Application Nos.: 62/644,912, filed on Mar. 19, 2018; 62/658,739, filed on Apr. 17, 2018; and 62/810,861 filed on Feb. 26, 2019. Each of the foregoing applications is incorporated herein by reference in their entirety. In some embodiments, pulse controller 38 provides a pulsed torque at a frequency of at least 1 Hz. In some embodiments, the pulse controller 38 provides a pulsed torque at a frequency of at least 10 Hz. In some embodiments, the pulse controller 38 provides a pulsed torque at a frequency of at least 20 Hz. By providing the energy storage 328, the faster reduction of the magnetic field in the rotor winding allows for a higher frequency pulsing. Some embodiments provide advantages in any application where a fast drop in torque is needed since a fast drop in the magnetic field of the rotor winding allows for a fast drop in torque.

Some embodiments provide advantages in any application, whether pulsing control is used or not, where a reduction in back EMF is needed since a fast drop in the magnetic field of the rotor winding allows for a fast drop in torque. In addition, if there is a fault in the stator, back EMF could cause damage to the machine, and fast control of the magnetic field would be advantageous.

### Reduced Capacitor Embodiments

In some embodiments, pulsed control is provided some of the time and a more continuous non-pulsed power is provided at other times. In some embodiments, the pulsed control is used when pulsed control provides a more efficient energy usage, and a continuous non-pulsed power is provided when pulsed control does not provide a more efficient energy usage. In some embodiments, the voltage and current to the rotor winding 204 provided during pulsed control are lower than the voltage and current to the rotor winding 204 during continuous non-pulsed phases. The energy supplied to a capacitor used as the energy storage 328 is E=(½)CV². As a result, a capacitor used for the energy storage 328 must be large in order to absorb all of the power during the continuous non-pulsed phase, since this uses a higher voltage than the pulsed control. Since the capacitor is on the rotor, providing a large capacitor on a rotating rotor is more challenging. If the capacitor size is reduced, the size of the rotating circuitry on the rotor can be reduced. Some embodiments provide circuitry on the rotor with a smaller capacitor. In some embodiments, voltage is applied to the capacitor during the pulsed control, and voltage is not applied to the capacitor during the continuous non-pulsed phases.

FIG. 4B is a logic chart of an embodiment that does not apply voltage to the capacitor during the continuous non-pulsed phases. In this embodiment, when the primary is on (step 404) an AC voltage is applied on the primary winding 312 so that the first switch Q18 and second switch Q19 are closed (step 408) and a DC voltage from the full-wave rectifier 324 is applied to the energy storage 328 and the rotor winding 204 in a first direction, creating a magnetic field in the rotor winding 204, as shown in FIG. 7A. When the primary is off (404) a determination is made on whether or not the voltage on the rotor is high or low (step 420). If the voltage on the rotor is low, indicating a pulsed control phase, then the first switch Q18 and second switch Q19 are open (step 412), causing the voltage and current described above regarding FIG. 7B. If the voltage on the rotor is not low (i.e. high), indicating a continuous non-pulsed phase, then either switch Q18 is opened and switch Q19 is closed (step 424) or switch Q18 is closed and switch Q19 is open (step 428).

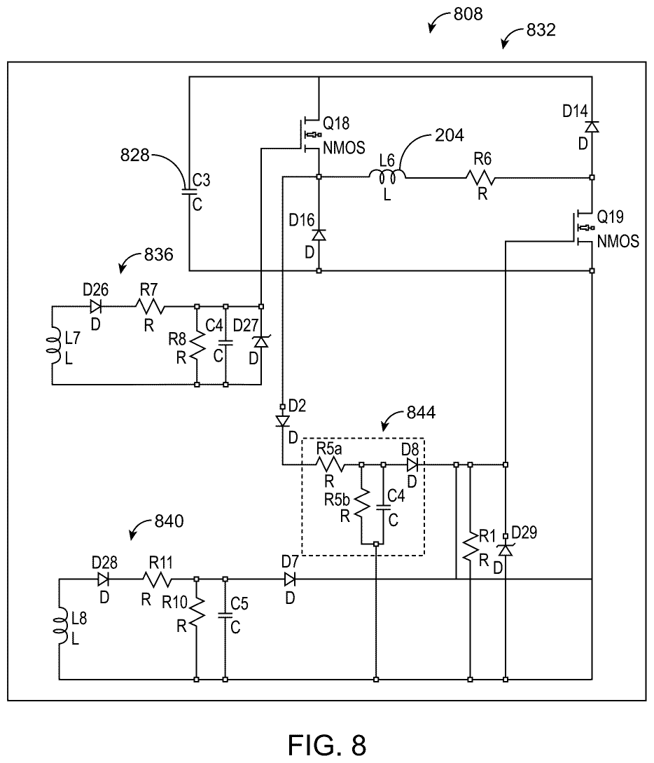

FIG. 8 is a schematic view of part of a secondary circuit 808 used in an embodiment that provides an open switch Q18 and closed switch Q19 (step 424). The secondary circuit 808 has an energy storage 828 in the form of a capacitor and a secondary H-bridge DC to DC converter 832 with a rotor winding 204. In some embodiments, the secondary H-bridge 832 has a first switch Q18 with a second diode D16 on a first side of the secondary H-bridge 832 and a first diode D14 with a second switch Q19 on a second side of the secondary H-bridge 832. A first control circuit 836 controls the first switch Q18, and a second control switch 840 controls the second switch Q19. In some embodiments, a detector circuit and switching circuit 844 is provided to provide additional control of the second switch Q19. In some embodiments, the detector circuit and switching circuit may instead be placed to provide additional control of the first switch Q18. In FIG. 8, the detector circuit and switching circuit 844 comprises a first leg with a first resistor R5b electrically connected to a first end of a second resistor R5a and a second leg with a capacitor C4 connected to a positive end of a diode D8. The first leg and the second leg are connected in parallel to the second control switch 840. A second end of the second resistor R5 is connected between the first switch Q18 and the rotor winding 204.

In operation, the detector circuit and switching circuit 844 keeps the second switch Q19 continuously closed, when a continuous non-pulsed power is provided and allows the second control switch 840 to open and close the second switch Q19 when a pulsed control is provided. In some embodiments, the switching circuit 844 keeps the second switch closed when a higher voltage is detected and allows the second control switch 840 to open and close when a lower voltage is detected. Such an operation relies on an implementation where the voltage through the rotor winding 204 when continuous non-pulsed power is provided is higher than the voltage through the rotor winding when pulsed control is provided.

FIG. 7C is a schematic view of part of the secondary circuit 308 shown in FIG. 3A, showing the energy storage 328 and the secondary H-bridge 332, comprising the rotor winding 204, the first switch Q18, the first diode D14, the second switch Q19, and the second diode D16. FIG. 7C shows the current flow 704 of a continuous non-pulsed power mode when the primary winding 312 (shown in FIG. 3A) is not providing power causing the first switch Q18 to open and the second switch Q19 to close (step 424). Current 704 flows through the second diode D16, through the rotor winding 204, and then through the second switch Q19, as shown.

Since power is directed through the rotor winding 204 during the continuous non-pulsed power mode when the primary winding 312 is not providing power instead of being directed to the energy storage 328, the energy storage 328 does not need to be large enough to store the energy of the continuous non-pulsed power. In some embodiments, the voltage provided during the continuous non-pulsed power mode is at least five times the voltage provided during the pulsed control mode. Since the energy stored in the capacitor is proportional to the square of the voltage, a capacitor for storing energy during the continuous non-pulsed power mode would need to be at least 25 times the size of a capacitor that is only used for storing energy for the pulsed control. Therefore, by providing the switching circuit 844 so that energy is not provided to the energy storage 328 during the continuous non-pulsed mode the capacitor size may be reduced by at least 25 times. Such a significant reduction in the size of a rotating capacitor is advantageous. In some embodiments, the voltage provided during the continuous non-pulsed power mode is at least two times the voltage provided during the pulsed control mode, so that the higher voltage is at least two times the lower voltage. In some embodiments, the higher voltage is greater than the lower voltage. In some embodiments, the higher voltage is at least five times the lower voltage.

In some embodiments, the wound field synchronous machine comprises at least one rotor winding, at least one stator winding, and at least one rotary transformer with energy storage. In some embodiments, the wound field synchronous machine is a multi-phase wound field synchronous machine, such as a three-phase, four-phase, or five-phase wound field synchronous machine, using a multiple phase AC excitation.

While this disclosure has been described in terms of several preferred embodiments, there are alterations, modifications, permutations, and various substitute equivalents, that fall within the scope of this disclosure. It should also be noted that there are many alternative ways of implementing the methods and apparatuses of the present disclosure. It is therefore intended that the following appended claims be interpreted as including all such alterations, modifications, permutations, and various substitute equivalents as fall within the true spirit and scope of the present disclosure.

What is claimed is:

1. An electric machine, comprising:
a power supply;
a transformer comprising at least one magnetic coupling;
a wound field synchronous machine, comprising:
a rotor winding;
a secondary circuit of the transformer electrically connected to the rotor winding, comprising:
a secondary winding;
a rectifier electrically connected across the secondary winding;
at least one switch for switching voltage between the rotor winding and the rectifier in a first direction; and
an energy storage arranged to:
store energy provided by the rectifier and the rotor winding; and
provide a voltage to the rotor winding in a second direction opposite the first direction when the switch switches off voltage between the rotor winding and the rectifier; and
a stator winding;
a power converter coupled between the power supply and the wound field synchronous machine, the power converter, comprising:
a stator winding power supply arranged to provide multiple phase AC excitation to the stator winding; and
a primary circuit of the transformer comprising a primary winding arranged to provide AC power to the primary winding.

2. The electric machine, as recited in claim 1, wherein the energy storage comprises a capacitor.

3. The electric machine, as recited in claim 1, wherein the secondary circuit further comprises an H-bridge DC to DC converter wherein the rotor winding provides a load for the H-bridge DC to DC converter.

4. The electric machine, as recited in claim 3, wherein the H-bridge DC to DC converter comprises:
the at least one switch;
a second switch;
a first diode; and
a second diode.

5. The electric machine, as recited in claim 4, wherein the at least one switch and the second switch are arranged to close when a voltage is applied from the rectifier.

6. The electric machine, as recited in claim 5, wherein the at least one switch, is controlled by a first control circuit, comprising:
a first control secondary winding;
a first low pass filter electrically connected to the first control secondary winding; and
at least one voltage divider;
and where the second switch is controlled by a second control circuit, comprising:
a second control secondary winding;
a second low pass filter electrically connected to the second control secondary winding; and
at least one voltage divider.

7. The electric machine, as recited in claim 4, wherein the electric machine is configured to have a first state operating in a pulsed control mode and a second state operating in a continuous non-pulsed mode, wherein the secondary circuit further comprises:
a first control circuit controllable connected to the at least one switch;
a second control circuit controllable connected to the second switch; and
a detector circuit for detecting if the electric machine is operating in the pulsed control mode or the continuous non-pulsed mode and maintaining at least one of the at least one switch and the second switch in a continuously closed state when the continuous non-pulsed mode is detected and wherein both the at least one switch and the second switch are closed when a pulsed control mode is detected and a voltage is applied from the rectifier.

8. The electric machine, as recited in claim 4, wherein the electric machine is configured to have a first state operating in a pulsed control mode and a second state operating in a continuous non-pulsed mode, wherein the secondary circuit further comprises:
a first control circuit controllable connected to the at least one switch;
a second control circuit controllable connected to the second switch; and
a detector circuit for detecting if a voltage applied to the rotor winding is a higher voltage or a lower voltage and maintaining at least one of the at least one switch and the second switch in a continuously closed state when the higher voltage is detected and wherein both the at least one switch and the second switch are closed when the lower voltage is detected and a voltage is applied from the rectifier.

9. The electric machine, as recited in claim 1, wherein the power converter comprises a pulse controller.

10. The electric machine, as recited in claim 9, wherein the pulse controller is adapted to provide a pulsed torque at a frequency of at least 1 Hz.

11. The electric machine, as recited in claim 1, wherein the primary circuit is adapted to provide soft switching.

12. The electric machine as recited in claim 1, wherein the energy storage reduces back EMF.

13. A method for providing excitation for rotor winding in an externally excited synchronous machine, comprising:
providing an AC excitation of a primary winding;
receiving on a secondary winding the AC excitation from the primary winding and generating an AC voltage;
rectifying the AC voltage to provide a DC voltage;
applying the DC voltage to a rotor winding; and
switching the DC voltage between on and off to provide a pulsed DC voltage, wherein when the pulsed DC voltage is on, the pulsed DC voltage is applied in a first direction to the rotor winding and an energy storage and wherein when the pulsed DC voltage is off the energy storage applies a voltage in a second direction opposite the first direction to the rotor winding.

14. The method, as recited in claim 13, wherein the energy storage comprises a capacitor.

15. The method, as recited in claim 13, wherein the switching the DC voltage between on and off, comprises:
receiving a voltage at a first control secondary winding; and
using the voltage to switch the DC voltage between on and off.

16. The method, as recited in claim 15, wherein the switching the DC voltage between on and off, further comprises providing the voltage to a first low pass filter electrically connected to the first control secondary winding before using the voltage to switch the DC voltage between on and off.

17. The method, as recited in claim 16, wherein the switching the DC voltage between on and off, further comprises passing the voltage to a voltage divider electrically connected to the first low pass filter before using the voltage to switch the DC voltage between on and off.

18. The method, as recited in claim 13, further comprising pulsing the AC excitation of the primary winding at a frequency of at least 1 Hz.

19. The method, as recited in claim 18, wherein the pulsing of the AC excitation comprises providing soft switching.

20. The method as recited in claim 13, wherein the energy storage reduces back EMF.

21. The method, as recited in claim 13, further comprising:
providing a pulsed control mode;
providing a continuous non-pulsed mode;
detecting whether the externally excited synchronous machine is operating in the pulsed control mode or the continuous non-pulsed mode;
applying voltage to the energy storage when operating in the pulsed control mode is detected; and
not applying voltage to the energy storage when the continuous non-pulsed mode is detected.

22. The method, as recited in claim 13, further comprising:
detecting whether the DC voltage applied to the rotor winding is a higher voltage or a lower voltage;
applying voltage to the energy storage when a lower voltage is detected and an AC excitation is received from the primary winding; and
not applying voltage to the energy storage when the higher voltage is detected and no AC excitation is received from the primary winding.
